(19) United States
(12) Patent Application Publication
(10) Pub. No.: US 2020/0010273 A1
(43) Pub. Date: Jan. 9, 2020

(54) SYSTEMS AND METHODS FOR AUTOMATED PRODUCT SORTING AND ORDER FULFILLMENT USING DRONES WITHIN A FACILITY

(71) Applicant: Walmart Apollo, LLC, Bentonville, AR (US)

(72) Inventors: Jason Bellar, Bella Vista, AR (US); Jeremy L. Velten, Bella Vista, AR (US)

(21) Appl. No.: 16/502,229

(22) Filed: Jul. 3, 2019

Related U.S. Application Data
(60) Provisional application No. 62/694,272, filed on Jul. 5, 2018.

(51) Int. Cl. B65G 1/137

(52) U.S. Cl. CPC B65G 1/1373

(57) ABSTRACT

Exemplary embodiments describe a system, a method and computer-readable medium for fulfilling orders. Embodiments include a server, an automated sorting system and a drone. The automated sorting system determines an item is associated with an online order based on scanning an identifier affixed to the item and the order data stored at the server. The automated sorting system determines the status for the order associated with the item. If the order is in-process, then the automated sorting system transmits instructions to the drone to transport the item to the location of the order container associated with the order. If the order is pending, then the automated sorting system sorts the item into a container, and scans and associates the container identifier with the order.

### RELATED APPLICATION

This application claims priority to, and the benefit of, U.S. Provisional Patent Application No. 62/694,272, filed Jul. 5, 2018, entitled “ Systems and Methods for Automated Product Sorting and Order Fulfillment Using Drones Within a Facility”, the contents of which are incorporated herein by reference in their entirety.

### BACKGROUND

In a retail facility, the delivery, unloading, and sorting of products at the facility is an important component of the efficient operation of the facility. These delivery, unloading and sorting processes often involve unloading items from an external delivery vehicle into the facility. Once within the facility, the items may be sorted into appropriate categories and then delivered to various parts of the facility.

### BRIEF DESCRIPTION OF THE DRAWINGS

Some embodiments are illustrated by way of example in the accompanying drawings and should not be construed to limit the present disclosure. The accompanying drawings, which are incorporated in and constitute a part of this specification, illustrate one or more embodiments of the invention and, together with the description, help to explain the invention. In the drawings:

FIG. 1 is a block diagram showing a fulfillment system in terms of modules, according to an example embodiment;

FIG. 2 is a flow chart showing an example method for fulfilling orders at an automated sorting system in a facility, according to an example embodiment;

FIG. 3 is a schematic showing an example automated sorting system and exemplary drones to fulfill orders, according to an example embodiment;

FIG. 4 illustrates a network diagram depicting a system for implementing the fulfillment system, according to an example embodiment; and

FIG. 5 is a block diagram of an exemplary computing device that may be used to implement exemplary embodiments of the fulfillment system described herein.

### DETAILED DESCRIPTION

Exemplary embodiments provide an automated product sorting and order fulfillment system. In one embodiment, items are sorted into categories using an automated sorting system. One of the categories is an online order category, which refers to items that are part of an order placed by a customer via a retailer's website, mobile app or other means. The order may be a pick-up at store order or a delivery order. Once an item is determined to be part of an online order, the automated sorting system physically diverts or directs the item to a particular portion of the automated sorting system, such as a lane, a section or a conveyor belt. The automated sorting system retrieves an order identifier number associated with the sorted item, and determines whether the order fulfillment has begun. If the order fulfillment has begun or is in-process, the automated sorting system transmits instructions to a drone to transport the item to the location of an existing container associated with the order. If the order fulfillment has not begun or is pending, then the automated sorting system physically sorts the item into a new container, and associates the new container with the order. The container may be a tote, a box, a tray or other container apparatus that can hold or store one or more items. As used herein, the container associated with an order holds or stores item(s) to fulfill an online order. The container has a machine-readable identifier affixed to it that uniquely identifies the container. The machine-readable identifier may be a barcode, a QR code, an RFID tag, an NFC tag, other Bluetooth enabled tags, or other machine-readable identifiers.

In an example embodiment, the automated sorting system includes multiple lanes and conveyor belts, where each lane and belt is associated with one or more sorting categories. The automated sorting system, which may be, but is not limited to, a Flexible Automated Sortation Technology (FAST) system, scans machine-readable identifiers of each item provided to the automated sorting system and diverts the item to its appropriate lane and conveyor belt/rollers based on the identified category. In an example embodiment, one or more of the lanes and conveyor belts/rollers are associated with the online order category. The automated sorting system first directs the item towards a proximal end of the lane, and the conveyor belt/rollers then convey the item towards a distal end of the lane where a container and/or a drone is disposed. The drone may be an aerial or ground drone and may pick up the item for transport.

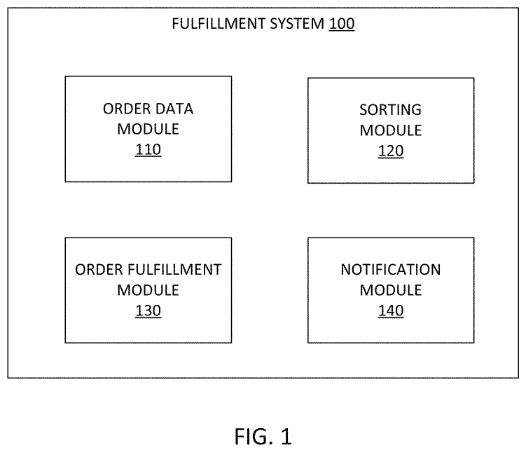

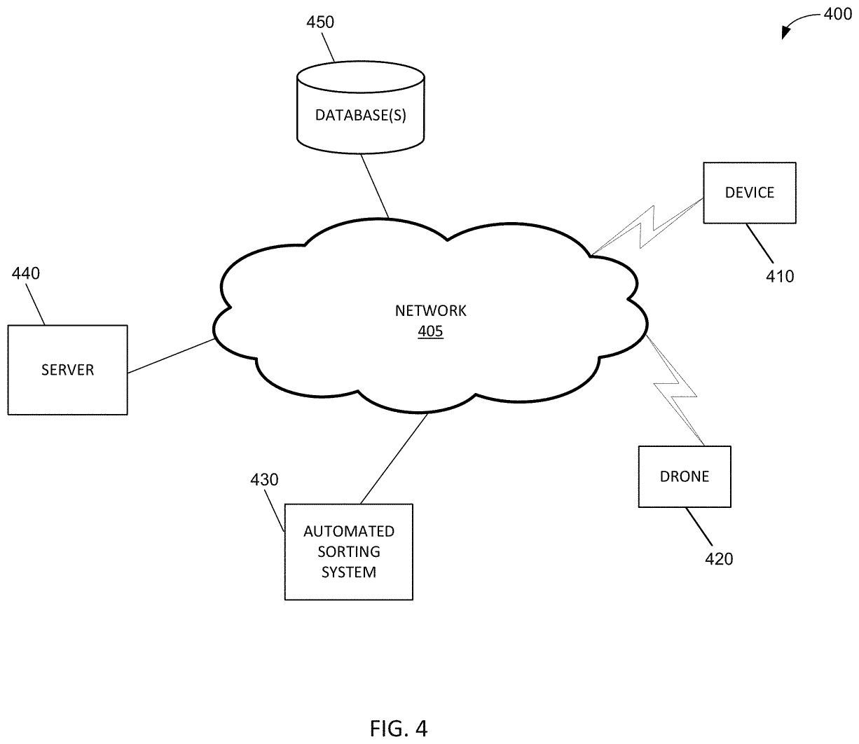

FIG. 1 is a block diagram showing a fulfillment system 100 in terms of modules for an example embodiment. One or more modules may be implemented using server 440 shown in FIG. 4 while other modules may be implemented using the automated sorting system 430 shown in FIG. 4. The modules include an order data module 110, a sorting module 120, an order fulfillment module 130 and notification module 140. The modules may include various circuits, circuitry and one or more software components, programs, applications, or other units of code base or instructions configured to be executed by one or more processors. Although modules 110, 120, 130 and 140 are shown as distinct modules in FIG. 1, it should be understood that modules 110, 120, 130 and 140 may be implemented as fewer or more modules than illustrated. It should be understood that modules 110, 120, 130 and 140 may communicate with one or more components included in system 400 (FIG. 4), such as device 410, drone 420, automated sorting system 430, server 440 and database(s) 450.

The order data module 110 may be a hardware or software-implemented module configured to analyze and manage order data for an order placed by a customer. The data may include an order identifier number, an order status, an order container identifier, and an order container location. As used herein, the order status refers to the fulfillment status of the order (e.g. pending, in-process, completed). As used herein, the order container location refers to the location of the container used to fulfill the order and the order container identifier refers to the identifier affixed to the container used to hold the items to fulfill the order identified by the order identifier number. The order data also includes data for one or more items that are part of the order. The order data may also include customer information, pickup date, pickup location delivery date, delivery address, payment status, and the like.

The sorting module 120 may be a hardware or software-implemented module configured to receive data related to items scanned at the automated sorting system and may be integrated into the product sorting apparatus described herein. Machine-readable identifiers are associated with items that are scanned by the automated sorting system using a scanner or other suitable readers. The sorting module 120 identifies the item information and sorts the item into one of multiple categories by routing or moving the item towards one of the lanes or sections of the automated sorting system. In one embodiment, the automated sorting system sorts items by diverting the item to a conveyor belt or rollers associated with the category identified for the item after scanning. One of the sorting categories may include an online order category. Items that are part of an order placed by a customer via the retailer's website or mobile app are sorted into the online order category.

The order fulfillment module 130 may be a hardware or software-implemented module configured to retrieve an order identifier number associated with the item sorted into the online order category. The order fulfillment module 130 may also be configured to determine an order status for the order associated with the order identifier number, and perform appropriate steps depending on whether the order is in-process or is pending. As used herein, the order status indicates the fulfillment status of the order. If the order fulfillment has not begun, that is no items of the order have been picked to fulfill the order, then the order status is set to pending. If the order fulfillment has begun, that is at least one item of the order has been picked, then the order status is set to in-process. If the order fulfillment is completed, that is all the items of the order have been picked, then the order status is set to ‘completed’. The order status is a data field stored in the server or the database along with other order data associated with an order.

The notification module 140 may be a hardware or software-implemented module configured to generate and transmit a notification message to a device (e.g., mobile device or other computing device) of the customer associated with the order. For example, when the order status is set to completed, the notification module 140 may transmit a notification to the customer's device informing the customer that his or her order is fulfilled and/or is ready for pickup at the facility.

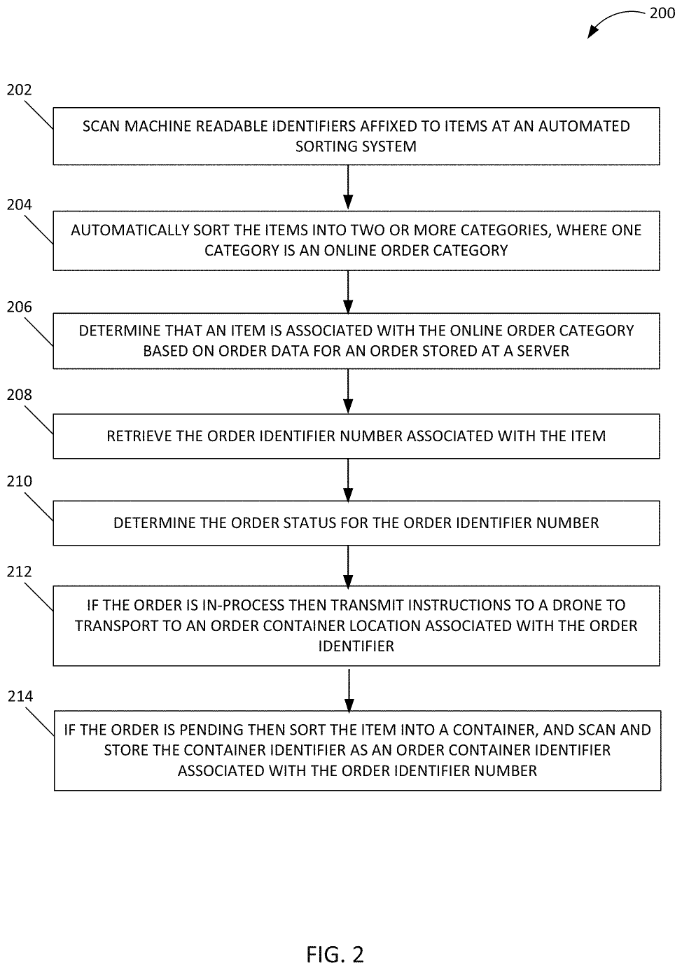

FIG. 2 is a flow chart showing an example method 200 for fulfilling orders at an automated sorting system in a facility, according to an example embodiment. The method 200 may be performed using the modules in the fulfillment system 100 shown in FIG. 1.

At step 202, the sorting module 120 scans machine-readable identifiers affixed to items that are provided to the automated sorting system. In a non-limiting example, the automated sorting system sorts items delivered to the facility in a transport vehicle from a distribution center or supplier. The automated sorting system sorts these items to facilitate storage of the items within the facility. The automated sorting system also sorts these items to facilitate fulfillment of orders.

At step 204, the sorting module 120 automatically sorts the items into two or more categories, where one of the categories is an online order category. In some cases, the facility may not have the item ordered by the customer, and may have it delivered by a distribution center or a supplier. Such items that are part of an online order are sorted into the online order category.

At step 206, the sorting module 120 determines that an item being scanned is associated with the online order category based on order data stored at a server (e.g., server 440). At step 208, the order fulfillment module 130 retrieves the order identifier number associated with the item. As described herein, the server stores order data, including an order identifier number.

At step 210, the order fulfillment module 130 determines the order status for the order identifier number. As used herein, the order status refers to the fulfillment status of the order.

At step 212, the order fulfillment module 130 transmits instructions to a drone to transport the item to an order container location associated with the order identifier number if the order status is in-process. The order container location refers to the location of the order container used to hold other items needed to fulfill the order associated with the order identifier number. The order container may be located at one of various stations or areas within the facility depending on the order fulfillment status of the associated order. For example, the order container may be located at backroom storage so that one or more items from the backroom storage can be placed in the container to fulfill the associated order. As another non-limiting example, the order container may be located at a staging area where items for an online order are packed in a box for customer pickup or delivery. As another non-limiting example, the order container may be located within a particular department of the facility (e.g., toys, home improvement, clothing, etc.) so that one or more items from the particular department can be placed in the container to fulfill the associated order.

In an example embodiment, the order fulfillment module 130 determines the size and weight of the item, and transmits instructions to a ground drone to transport the item if the size and weight are more than a threshold or predefined values. If the size and weight of the item are less than a threshold or predefined values then the order fulfillment module 130 transmits instructions to an aerial drone to transport the item. The threshold or predefined values may indicate a size or weight of package that an aerial drone is capable of transporting. In other embodiments, the order fulfillment module 130 may choose between an aerial drone and a ground drone based on the availability of the respective drones.

At step 214, if the order status is pending, then the order fulfillment module 130 sorts the item into a container, and scans and stores the machine-readable identifier affixed to the container as the order container identifier is associated with the order.

In some embodiments, the order fulfillment module 130 may instruct the drone to transport multiple items at the same time if they are associated with the same order. In another embodiment, the order fulfillment module 130 may instruct the drone to transport multiple items at the same time to different locations based on the location of respective different order containers associated with the items.

In an example embodiment, the notification module 140 generates and transmits a notification to the customer's device (e.g., device 410) informing the customer that the order has been fulfilled and is ready for pickup or delivery. In other embodiments, the notification module 140 may generate and transmit a notification to the customer's device informing the customer of the fulfillment status of the order. The notification module 140 may retrieve the fulfillment status of the order from the server or database. In some embodiments, the notification module 140 may generate and transmit a notification to the customer's device when an item is scanned at the automated sorting system, informing the customer that the item has arrived at the facility.

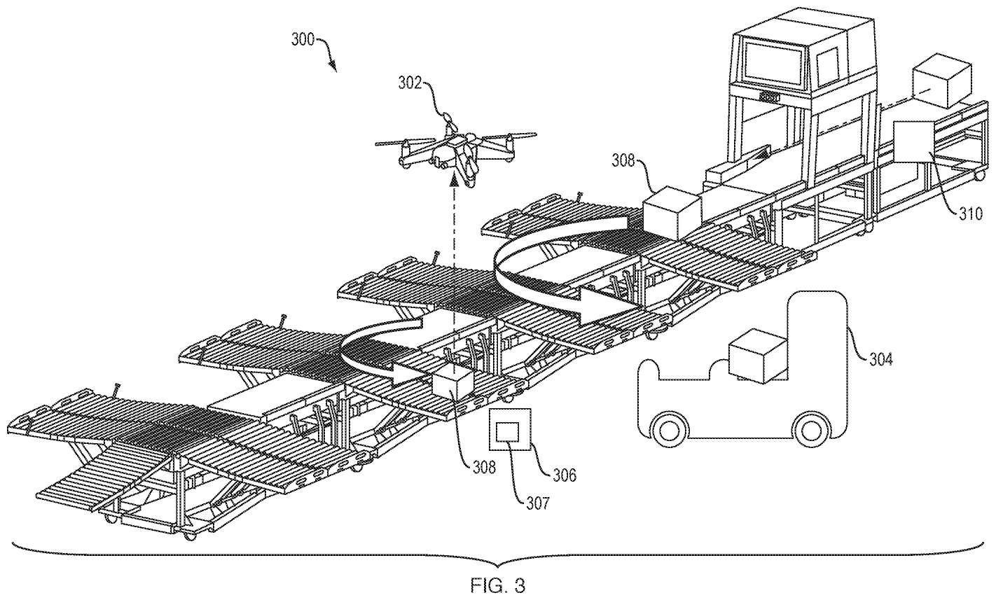

FIG. 3 is a schematic showing an example automated sorting system and exemplary drones to fulfill orders, according to an example embodiment. As described herein, an exemplary automated sorting system 300 includes multiple lanes or sections to automatically sort items 308 into categories. The automated sorting system 300 includes a processor and communication interface that enables communication with drones 302, 304.

In one embodiment, the automated sorting system 300 transmits instructions to the aerial drone 302 to transport item 308 to the location of the order container associated with the order that the item 308 belongs to as identified by the automated sorting system 300. In another embodiment, the automated sorting system 300 transmits instructions to the ground drone 304 to transport item 308 to the location of the order container associated with the order that the item 308 belongs to as identified by the automated sorting system 300. Depending on the size, dimensions, weight or other factors of the item, and/or depending on the availability of drones, the automated sorting system 300 may choose between the aerial drone 302 and the ground drone 304.

As described herein, the automated sorting system 300 transmits instructions to transport the item 308 when the associated order status is in-process. When the order status for the order associated with the item 308 is pending (i.e. has not started fulfillment), the item is sorted into a container 306. A machine-readable identifier 308 is affixed to the container 306. The automated sorting system 300 scans the machine-readable identifier 308 and associates it with the order that the item 308 belongs to as identified by the automated sorting system 300.

In an example embodiment, the automated sorting system 300 includes a charging interface 310 that is configured to connect to an aerial or ground drone to charge the battery of the drone.

FIG. 4 illustrates a network diagram depicting a system 400 for implementing the fulfillment system, according to an example embodiment. The system 400 can include a network 405, a device 410, a drone 420, an automated sorting system 430, server 440, and database(s) 450. Each of the device 410, drone 420, automated sorting system 430, server 440, and database(s) 450 is in communication with the network 405.

In an example embodiment, one or more portions of the communications network 405 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

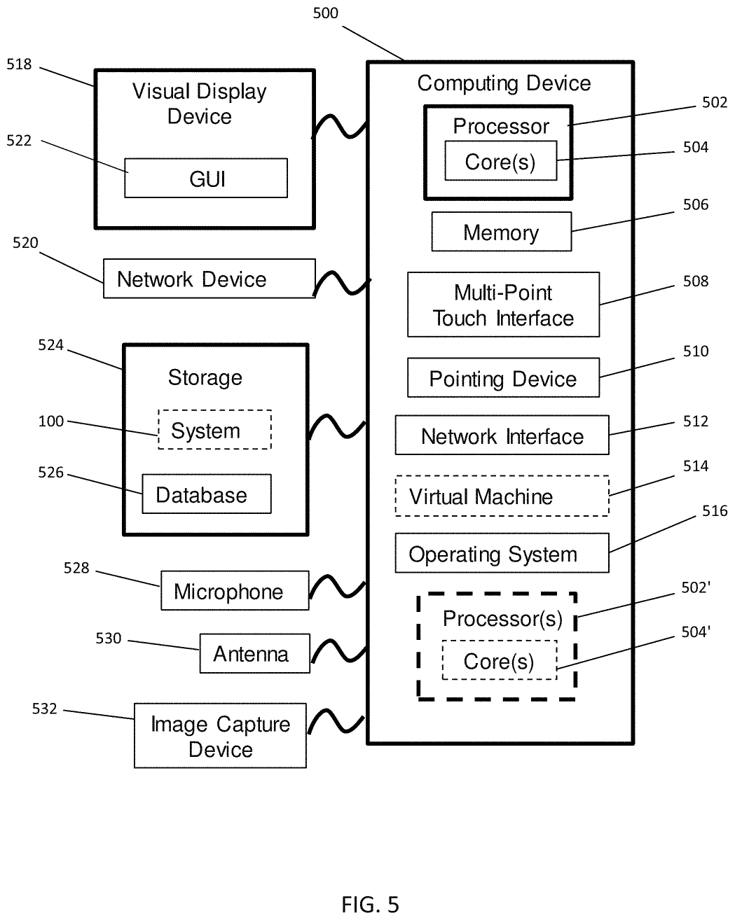

The device 410 may include, but is not limited to a computing system including a processor, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 410 may connect to network 405 via a wired or wireless connection. The device 410 may include one or more components of computing device 500 described in connection with FIG. 5. The device 410 may be used by a customer to input information to place an order for pickup or delivery. The server 440 and database(s) 450 stores order data based on the information entered by the customer at the device 410.

The drone 420 may be an unmanned aerial vehicle or unmanned ground vehicle. The drone may be a commercially available or other drone capable of performing the functionalities described herein, including operating in an indoor environment. In one embodiment, the drone is capable of autonomous flight or navigation through a facility, is aware of its surroundings, and is programmable. The aerial drone may include hooks or other item lifting mechanisms. The ground drone may include a platform for supporting items. The drone may also include a processing device or an on-board computing device and memory to store instructions or data, and communication ability to communicate with the automated sorting system 430. In an example embodiment, the drone 420 may be capable of automatically loading and unloading items.

The automated sorting system 430 may include multiple lanes and conveyor belts or rollers, where each lane and belt is associated with one or more sorting categories. The automated sorting system, which may be, but is not limited to, a Flexible Automated Sortation Technology (FAST) system, scans machine-readable identifiers of each item provided to the automated sorting system and diverts the item to its appropriate lane and conveyor belt/rollers based on the identified category. In an example embodiment, the automated sorting system 430 includes a computing device or an embedded computing device that enables the automated sorting system to transmit instructions to the drone 420 and retrieve data from the server 440 or database(s) 450 via network 405. The computing device or embedded computing device of the automated sorting system 430 may include one or more components of the computing device 500 described in connection with FIG. 5.

In an example embodiment, portions of the fulfillment system 100 are included on the server 440 and other portions are included in the automated sorting system 430. For example, the order data module 110 and the notification module 140 may be included on the server 440 and the server 440 may perform the related functionalities. The sorting module 120 and the order fulfillment module 130 may be included on the automated sorting system 430 and the automated sorting system 430 may perform the related functionalities.

Each of the database(s) 450 and the server 440 is connected to the network 405 via a wired or wireless connection. Although not shown, server 440 can be (directly) connected to the database(s) 450. The server 440 includes one or more computers or processors configured to communicate with the device 410, the drone 420, and/or the automated sorting system 430 via network 405. The server 440 hosts one or more applications or websites accessed by the device 410, the drone 420, and the automated sorting system 430, and/or facilitates access to the content of database(s) 450. Database(s) 450 comprise one or more storage devices for storing data and/or instructions (or code) for use by the server 440, device 410, drone 420, and automated sorting system 430. Database(s) 450 and/or server 440 may be located at one or more geographically distributed locations from each other or from the device 410, the drone 420, or the automated sorting system 430. Alternatively, database(s) 450 may be included within servers 440.

FIG. 5 is a block diagram of an exemplary computing device 500 that may be used to implement exemplary embodiments of the fulfillment system 100 described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the fulfillment system 100. The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522 that may be provided in accordance with exemplary embodiments. The computing device 500 may include other I/O devices for receiving input from a user, for example, a keyboard or other suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer-readable media, for storing data and computer-readable instructions and/or software that implement exemplary embodiments of the fulfillment system 100 described herein. Exemplary storage device 524 may also store one or more databases for storing suitable information required to implement exemplary embodiments. For example, exemplary storage device 524 can store one or more databases 526 for storing information, such order data, customer information, drone identifying information, order container locations, and/or other information to be used by embodiments of the system 100. The databases may be updated manually or automatically at a suitable time to add, delete, and/or update one or more items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or other device suitable for interfacing the computing device 500 to a type of network capable of communication and performing the operations described herein. Moreover, the computing device 500 may be a computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 500 may run an operating system 516, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, or another operating system capable of running on the computing device and performing the operations described herein. In exemplary embodiments, the operating system 516 may be run in native mode or emulated mode. In an exemplary embodiment, the operating system 516 may be run on one or more cloud machine instances.

In an exemplary embodiment, one or more of the exemplary embodiments include one or more localized IoT devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI includes substantially all continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data.

The description herein is presented to enable a person skilled in the art to create and use a computer system configuration and related method and article of manufacture for automated sorting of items and order fulfillment. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for fulfilling online orders, the system comprising:
a server storing order data for an order, the order data including an order identifier number, an order status, an order container identifier, and an order container location;
an automated sorting system in communication with the server and configured to:
scan machine readable identifiers affixed to a plurality of items, and
automatically sort the plurality of items into two or more categories, wherein one of the categories is an online order category;
a container having a machine readable identifier affixed thereto and disposed near the automated sorting system; and
a drone in communication with the automated sorting system, wherein the automatic sorting by the automated sorting system:
determines that an item of the plurality of items is associated with the online order category based on a machine readable identifier affixed to the item and the order data stored at the server,
retrieves the order identifier number associated with the item,
determines the order status for the order identifier number, and
in response to determining that the order status indicates that the order is in-process, transmits instructions to the drone to transport the item to the order container location associated with the order identifier number, and
in response to determining that the order status indicates that the order is pending, sorts the item into the container and scans and stores the machine readable identifier affixed to the container as the order container identifier associated with the order identifier number.

2. The system of claim 1, wherein the automated sorting system further includes:
a charging interface configured to connect to the drone to charge a battery of the drone.

3. The system of claim 1, wherein the drone is at least one of a ground drone or an aerial drone.

4. The system of claim 3, wherein the automated sorting system is further configured to:
determine a size and a weight of the item;
transmit instructions to the ground drone if the size and the weight are more than predefined values; and
transmit instructions to the aerial drone if the size and the weight are less than the predefined values.

5. The system of claim 1, wherein the machine readable identifier affixed to the container is at least one of a barcode, a QR code, an RFID tag, an NFC tag, and a Bluetooth enabled tag.

6. The system of claim 1, wherein the server is configured to transmit a notification to a user device of a customer associated with the order data when the order status is set to a completed status.

7. The system of claim 1, wherein the automated sorting system includes a lane corresponding to the online order category and the item sorted into the online order category is directed to a proximal end of the lane.

8. The system of claim 7, wherein the container is disposed at a distal end of the lane corresponding to the online order category to receive the item sorted into the online order category.

9. The system of claim 7, wherein the drone is disposed at a distal end of the lane corresponding to the online order category to receive the item sorted into the online order category.

10. A method for fulfilling online orders, the method comprising:
scanning machine readable identifiers affixed to a plurality of items at an automated sorting system;
automatically sorting the plurality of items into two or more categories, wherein one of the categories is an online order category;
determining that an item of the plurality of items is associated with the online order category based on order data for an order stored at a server, wherein the order data includes an order identifier number, an order status, an order container identifier and an order container location;
retrieving the order identifier number associated with the item;
determining the order status for the order identifier number;
in response to determining that the order status indicates that the order is in-process, transmitting instructions to a drone to transport the item to an order container location associated with the order identifier number; and
in response to determining that the order status indicates that the order is pending, sorting the item into a container, and scanning and storing a machine readable identifier affixed to the container as an order container identifier associated with the order identifier number.

11. The method of claim 10, wherein the automated sorting system includes a charging interface configured to connect to the drone to charge a battery of the drone.

12. The method of claim 10, wherein the drone is at least one of a ground drone or an aerial drone.

13. The method of claim 12, further comprising:
determining a size and a weight of the item;
transmitting instructions to the ground drone if the size and the weight are more than predefined values; and
transmitting instructions to the aerial drone if the size and the weight are less than or meets the predefined values.

14. The method of claim 10, wherein the machine readable identifier affixed to the container is at least one of a barcode, a QR code, an RFID tag, an NFC tag, and a Bluetooth enabled tag.

15. The method of claim 10, further comprising transmitting a notification from the server to a user device of a customer associated with the order data when the order status is set to a completed status.

16. The method of claim 10, further comprising directing the item sorted into the online order category towards a lane of the automated sorting system that corresponds to the online order category.

17. A non-transitory machine readable medium storing instructions executable by a processing device, wherein execution of the instructions causes the processing device to implement a method for fulfilling online orders, the method comprising:
scanning machine readable identifiers affixed to a plurality of items at an automated sorting system;
automatically sorting the plurality of items into two or more categories, wherein one of the categories is an online order category;
determining that an item of the plurality of items is associated with the online order category based on order data for an order stored at a server, wherein the order data includes an order identifier number, an order status, an order container identifier and an order container location;
retrieving the order identifier number associated with the item;
determining the order status for the order identifier number;
in response to determining that the order status indicates that the order is in-process, transmitting instructions to a drone to transport the item to an order container location associated with the order identifier number; and
in response to determining that the order status indicates that the order is pending, sorting the item into a container, and scanning and storing a machine readable identifier affixed to the container as an order container identifier associated with the order identifier number.

18. The non-transitory machine readable medium of claim 17, wherein the method further comprises:
determining a size and a weight of the item;
transmitting instructions to the ground drone if the size and the weight are more than a predefined values; and
transmitting instructions to the aerial drone if the size and the weight are less than or meets the predefined values.

19. The non-transitory machine readable medium of claim 17, wherein the machine readable identifier affixed to the container is at least one of a barcode, a QR code, an RFID tag, an NFC tag, and a Bluetooth enabled tag.

20. The non-transitory machine readable medium of claim 17, wherein the method further comprises transmitting a notification to a user device of a customer associated with the order data when the order status is set to a completed status.
